(19) United States
(12) Patent Application Publication
(10) Pub. No.: US 2006/0026051 A1
(43) Pub. Date: Feb. 2, 2006

(54) System and method for directly scheduling health care patient appointments

(75) Inventor: Eric A. Rose, Ashland, MA (US)

Correspondence Address: DOWNS RACHLIN MARTIN PLLC, 199 MAIN STREET, P O BOX 190, BURLINGTON, VT, 05402-0190, US

(73) Assignee: IDX Investment Corporation, S. Burlington, VT (US)

(21) Appl. No.: 10/903,105

(22) Filed: Jul. 30, 2004

(51) Int. Cl. G06Q 10/00

(52) U.S. Cl. 705/8

(57) ABSTRACT

A direct scheduling system (100,300) that permits automatic appointment scheduling in a computer network environment (304). The system includes a scheduler (108,320) that utilizes scheduling parameters (124,336) to schedule appointments (104) of various types. A user interface (112,324) allows a requester to request that the scheduler schedule an appointment by identifying, among other things, the type of appointment so that a digital appointment identifier (172,332) is created. A mapper (116,328), located between the user interface and scheduler, is configured to map each appointment requested to the corresponding one or more scheduling parameters that the scheduler needs to schedule an appointment of the desired type.

### FIELD OF THE INVENTION

The present invention generally relates to the field of scheduling. In particular, the present invention is directed to a system and method for directly scheduling health care patient appointments.

### BACKGROUND OF THE INVENTION

Some present state-of-the-art Internet-based health care enterprise solutions products, e.g., the PATIENT ONLINE® and REFERRING PRACTICE ONLINE™ tools available from IDX Systems Corp., Burlington, Vt., have features that allow patients and referring physicians, respectively, to schedule appointments with physicians on-line, i.e., over the World Wide Web (WWW) via a browser. Generally, this on-line scheduling proceeds as follows. A patient or referring physician (or a referring physician's assistant), hereinafter “requester,” logs onto the computer system of the physician with whom an appointment is desired, i.e., the “appointment physician.” Typically, this is done from a browser on the requester's computer, but being a WWW-based system, may generally be done from virtually any device having a browser and WWW access.

Once logged on, the requester typically has access to various features of the appointment physician's enterprise software, e.g., the one of PATIENT ONLINE® and REFERRING PRACTICE ONLINE™ tools mentioned above. Depending upon how the appointment physician's software is configured, the requester may be able to view appointment times available for the appointment physician. The requester then reviews the available appointment times, selects one or more, and using the browser, submits an electronic request via the appointment physician's enterprise software. In addition to the one or more selected appointment times, the electronic request typically includes sufficient information for the appointment physician to schedule an appointment, such as patient name, contact information and reason for appointment, among other things. Alternatively, if the appointment physician's software does not allow a requester to view available appointment times, the requester simply submits an electronic request containing information needed to schedule the appointment.

Once the electronic request has been made, the appointment physician's software posts the request to a task list as a task to be followed up upon by the appointment physician's staff. After the electronic request has been posted as a task, the software determines whether or not the request can be satisfied or how it can be most closely satisfied. After the staff has determined whether the appointment request can be satisfied or how the request can be best satisfied, the staff notifies the requester of the status of the request.

While state-of-the-art on-line health care scheduling tools add a measure of convenience to requesting and scheduling physician appointments, they have a number of shortcomings. For example, these scheduling tools require a relatively large amount of human interaction. That is, time and effort of the appointment physician's staff is needed to review the task lists to which the electronic requests are posted, to access and review the appointment physician's schedule to determine if, or how best, the request can be satisfied, and to follow up with the requester to advise the requester regarding the request. In addition, since the electronic request must be reviewed and acted upon by the appointment physician's staff, feedback to the requester is not immediate. Typically, it will take a number of hours to a day or more until the requester receives a response to the request. Consequently, what is needed, among other things, is an on-line scheduling tool that requires little, or no, human interaction to successfully schedule an appointment in response to an electronic appointment request and an on-line scheduling tool that provides a requester with immediate feedback on whether or not the requested appointment was scheduled. The present invention provides these, and other, features.

### SUMMARY OF THE INVENTION

In one aspect, the present invention is directed to a method of scheduling an event. The method includes the step of receiving a digital event request from a requester via a client device. Computer instructions that map the digital event request to at least one scheduling parameter are executed. Computer instructions that search for one or more available event times as a function of the at least one scheduling parameter are then executed.

In another aspect, the present invention is directed to a system for scheduling an event. The system comprises a scheduler operatively configured to schedule a plurality of events during corresponding times using a plurality of scheduling parameters. A user interface is operatively configured to: i) display a schedule request page to a requester; ii) receive a schedule request from a requester; and iii) permit a requester to generate a digital schedule request as a function of the schedule request. A mapper is operatively configured to receive the digital schedule request and digitally map the digital schedule request to at least one of the plurality of scheduling parameters.

### BRIEF DESCRIPTION OF THE DRAWINGS

For the purpose of illustrating the invention, the drawings show a form of the invention that is presently preferred. However, it should be understood that the present invention is not limited to the precise arrangements and instrumentalities shown in the drawings, wherein:

FIG. 1 is a high-level schematic diagram of a direct scheduling system of the present invention;

FIG. 2A is a screenshot of an appointment request page of the direct scheduling system of FIG. 1; FIG. 2B is a screenshot of an appointment selection page of the direct scheduling system of FIG. 1; FIG. 2C is a screenshot of an appointment scheduling page of the direct scheduling system of FIG. 1; FIG. 2D is a screenshot of an appointment confirmation page of the direct scheduling system of FIG. 1;

FIG. 3 is a high-level schematic diagram of a computer network containing a direct scheduling system of the present invention; and

FIG. 4 is a flow diagram illustrating a direct scheduling method according to the present invention.

### DETAILED DESCRIPTION OF THE DRAWINGS

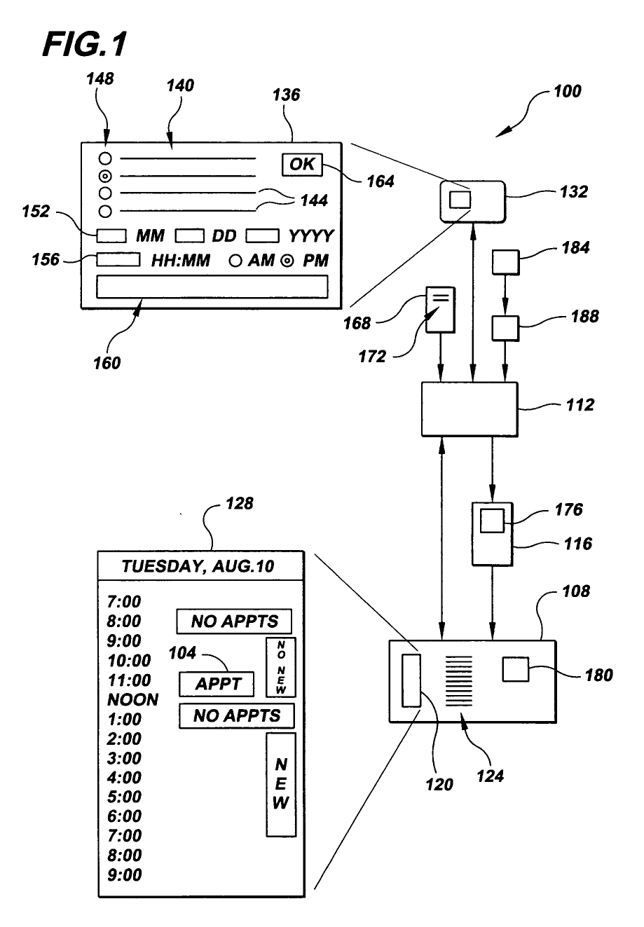

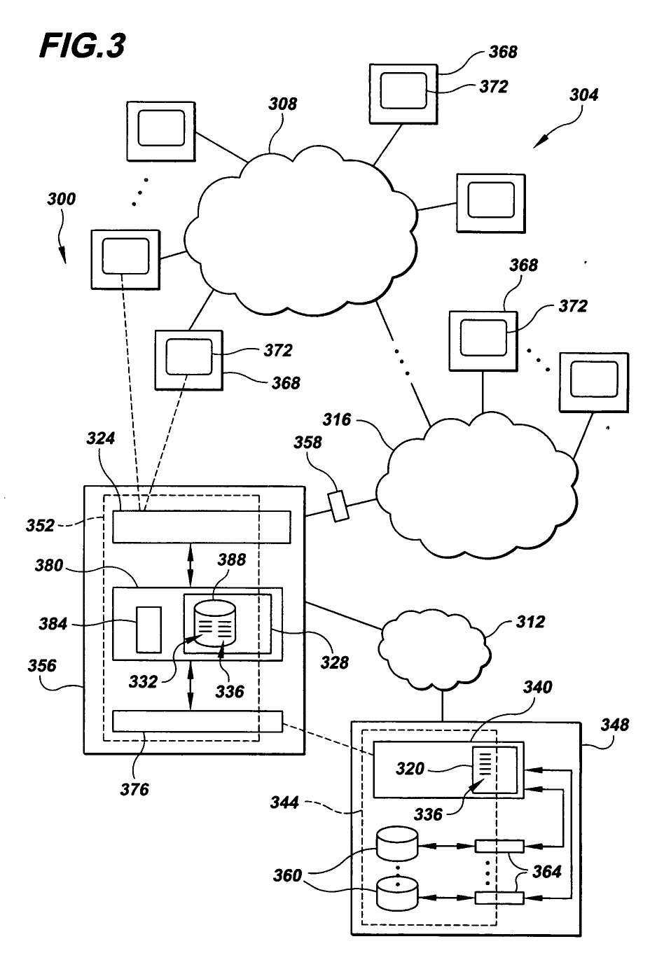

Referring now to the drawings, FIG. 1 shows an direct scheduling system 100 of the present invention. Generally, direct scheduling system 100 allows a requester (not shown), e.g., a patient, desiring to schedule one or more events 104, e.g., an appointment with a healthcare provider (not shown) such as a physician, imaging technician, etc., to schedule the event(s) in a user-friendly manner and in real time, without the need for any human action other than one or more actions that the requester may take in initiating the selection process through finalizing the scheduling of the event(s). In order to provide this and other functionality, direct scheduling system 100 may include a scheduler 108, a user interface 112 and a mapper 116, each of which may be implemented using any number of software/hardware architectures. One architecture is described below relative to FIG. 3 in connection with a global network, e.g., Internet, environment. However, those skilled in the art will readily appreciate that other software/hardware architectures may be accommodated and may depend on the type of environment, e.g., global network, local area network, wide area network, wireless network, and combinations thereof.

It is noted that the terms “appointment” and “event,” and like terms, are used herein somewhat interchangeably. However, it is noted that the term “event” and like terms are intended to be broader than the term “appointment” and like terms. Generally, an event encompasses an appointment, as well as many other happenings, such as meetings, telephone conferences, restaurant reservations, package deliveries, rounds of golf, etc., that may be scheduled, e.g., as a function of a start time, alone or in combination with a duration.

Scheduler 108 may be any application, module or set of computer instructions that provide the functionality to schedule events 104. Scheduler 108 may be any legacy or new scheduler. For example, scheduler 108 may be the scheduling module of any one of a variety of known enterprise systems. In the context of health care, scheduler 108 may be part of a health care enterprise system, such as any one of the FLOWCAST™, CARECAS™, GROUPCAST™, and IMAGECAST™ systems available from IDX Systems, Inc., Burlington, Vt. Often, scheduler 108 is customized to the entity, e.g., health care organization, such as a physician's office/group, imaging center/group, etc., utilizing the scheduler 108 to schedule events 104 on a schedule 120. For example, scheduler 108 may utilize various scheduling parameters that it may use, among other things, to determine the length of the event(s) 104 that need to be scheduled, to determine what time periods of schedule 120 are available for a particular type of event, and to identify the type of the event on the schedule.

For the sake of illustration, scheduling parameters 124 are described herein in the context of the scheduling of appointments (events) 120 for a physician (not shown) in a general practice. FIG. 1 illustrates 128 one day (Tuesday) of schedule 120, as represented by day calendar 128. In this example, day calendar indicates that this particular physician does not want any annual physical exams scheduled in the morning or evening and wants all initial new patient consultations to occur only between the hours of 1:00 p.m. and 7:00 p.m. In addition, this physician has blocked out the periods between 7:30 a.m. and 8:30 a.m. and between 12:30 p.m. and 1:00 p.m. in which no appointments are to be scheduled. As described below, scheduler 108 may use these schedule constraints to determine periods available for a requested appointment.

Scheduling parameters 124 utilized by scheduler 108 for this particular physician may simply be a set of codes, each corresponding to a particular type of appointment 104. For example, the physician may have the standard appointment types and corresponding appointment requirements and scheduling parameters 124 appearing in the following Table I:

TABLE I

| | | Scheduling |
|---|---|---|
| Appointment Type | Appointment Requirements | Parameters (124) |
| Annual physical | 2.0 hour duration | Physical |
| exam | Schedule exam room | ExamRm |
| | Schedule stress testing | StressTest |
| | equipment | |
| Medication | 0.75 hour duration | MedCon |
| consultation | Schedule consultation room | ConsultRm |
| New medication | 0.5 hour duration | MedFollowup |
| follow-up | Schedule consultation room | ConsultRm |
| New patient initial | 1.0 hour duration | NewPatient |
| intake | Schedule exam room | ExamRm |
| Cholesterol | .75 hour duration | CholCon |
| consultation | Schedule consultation room | ConsultRm |
| | Schedule blood test | Blood |
| Depression/anxiety | 1.5 hour duration | DAC |
| consultation | Schedule consultation room | ConsultRm |

Of course, the physician may make appointments of a type other than the standard types listed in Table I, e.g., appointments having highly variable duration requirements or made for a non-standard reason. In such case, non-standard appointments may be arranged through the physician's staff, e.g., in a conventional manner. It is noted that the information shown in Table I is fictitious and is provided merely to illustrate the present invention. Those skilled in the art will readily appreciate that the appointment (event) types, descriptions and scheduling parameters 124 may by any germane to the events being scheduled. Scheduler 108 may use scheduling parameters 124 to schedule an appointment 104, e.g., as described below in more detail.

User interface 112 may display to a requester a graphical user interface (GUI) 132 that allows the requester to communicate with scheduler 108 to schedule an event 104. User interface 112 may display an event request page 136 via GUI 132 that allows the requester to identify the type of appointment 104 desired to be scheduled. Since a requester will typically not be familiar with scheduling parameters 124 used by scheduler 108 in scheduling events 104, user interface 112 will typically allow the requester to request an event without the requester ever knowing the scheduling parameters 124 used by the scheduler. For example, event request page 136 may display a list 140 of event type descriptions 144 in easy to read format and may inform the user to identify which type of event 104 the requester desires to schedule based on the descriptions. For example, for the appointment (event) types listed in Table I, event request page 136 may display event type descriptions 144 in Table II.

TABLE II

| Appointment Type | Description |
|---|---|
| Annual physical exam | Annual physical examination. |
| Medication consultation | Consult doctor about medication(s). |
| New medication follow-up | Routine 2-month follow-up |
| | for new medication. |
| New patient initial intake | New patient initial appointment. |
| Cholesterol consultation | Consult doctor about controlling |
| | cholesterol levels. |
| Depression/anxiety consultation | Consult doctor about depression/ |
| | anxiety treatment. |

Event request page 136 may allow the requester to select the desired one (or more, in some embodiments) of the event types using one or more suitable selectors 148, such as a series of conventional radio buttons, check boxes, drop-down selector, etc. Alternatively, event request page 136 may include a text input region (not shown) that allows the requester to identify the desired event type(s) by inputting one or more characters, words, or character strings into the text input region. Those skilled in the art will readily appreciate that event request page 136 may utilize any of a wide variety of selection/identification means for allowing the requester to select the desired event type(s).

Event request page 136 may include a number of other selection/input means that allow the requester to select or input other information, e.g., constraints, that scheduler 108 may need to schedule one or more events 104 based upon the requester's selection of the corresponding event type(s), as just described. For example, event request page 136 may include a date selector/identifier 152 that allows the requester to select or identify the desired date(s) of the event corresponding to the event type(s) selected. Date selector/identifier 152 may be any suitable type of selector, e.g., a drop-down selector or typing field for each of the month, day, and year, a drop-down calendar that allows the requester to page through months and select a date by clicking on a particular day of the month, etc., or one or more character input fields that allow the requester to manually input numerals and/or letters and month names/abbreviations.

Event request page 136 may optionally include a time selector/identifier 156 that allows the requester to select or identify one or more particular time(s) or period(s) of the day, e.g., morning, afternoon, evening, etc., that the requester would like scheduler 108 to schedule the corresponding event(s) 104. Time selector/identifier 156 may be any suitable type of selector, e.g., a drop-down selector, one or more character input fields that allows the requester to manually input numerals and/or letters to identify a.m. or p.m., or one or more sets of radio buttons or check boxes, among others. Like the selection/identification means for the selection of event type(s), those skilled in the art will readily understand that request page may utilize any of a wide variety of desired date and/or time selection/identification means.

Event request page 136 may also optionally include a requester information input region 160 that allows the requester to input any information about the requester necessary for scheduler 108 to schedule an event 104 based on the requester's request. For example, in the context of the physician appointment scheduling context, this requester information may include the patient's name, date of birth, and contact information, among other things. Generally, scheduler 108 and/or the physicians staff would then use this information, among other things, to correlate event 104 to that particular patient and to follow up with the patient, e.g., if the scheduler was not able to schedule the requested event(s) or some other anomaly occurred. Requester information input region 160 may contain any type of input fields, selectors, etc., suitable for the type of information being input. These need not be described in detail herein, since they are well known in the art. In some embodiments of direct scheduling system 100, event request page 136 may not need requester information input region 160. For example, if the requester accesses event request page 136 by first logging into direct scheduling system 100 or interface thereto, e.g., via a logon screen, the login would typically obviate the need for the requester to provide personal information via event request page 136, since this information would already be know via the requester's account that allowed the requester to login.

Event request page 136 may further include a request transmit selector 164 that the requester selects when the requester is done providing the information necessary for scheduler 108 to schedule the desired event(s). Request transmit selector 164 may be a button-type or other type selector, such as an “OK” button, or the like. Once requester actuates request transmit selector 164, a digital event request 168, or portion thereof, may be sent to mapper 116. Generally, digital event request 168 is a digital signal that includes information corresponding to the data requester entered via event request page 136. The information in digital event request 168 may include a digital event identifier 172 for each type of event 104 the requester selected. Table III illustrates exemplary digital event (appointment) identifiers 172 for the appointment types identified in Tables I and II.

TABLE III

| Appointment Type | Digital Appointment Identifier (172) |
|---|---|
| Annual physical exam | DID1 |
| Medication consultation | DID2 |
| New medication follow-up | DID3 |
| New patient initial intake | DID4 |
| Cholesterol consultation | DID5 |
| Depression/anxiety consultation | DID6 |

In order for scheduler 108 to properly schedule an event for each event type selected by the requester using its internal scheduling parameters 124, each digital event identifier 172 must be correlated to the appropriate one or more scheduling parameters. This is a function of mapper 116. In this connection, mapper 116 may include any type of correlator 176, e.g., maps, lookup tables, etc., that enables this correlation. Table IV illustrates an exemplary lookup table for digital appointment identifiers 172 listed in Table III for the general practice physician example presented above. The lookup table of Table IV correlates each digital appointment identifier 172 to the corresponding scheduling parameters 124 of Table II that scheduler 108 needs to schedule appointments 104 of the appointment types of Tables I-III.

TABLE IV

| Digital Appointment Identifier | Scheduling Parameters (124) |
|---|---|
| DID1 | Physical |
| | ExamRm |
| | StressTest |
| DID2 | MedCon |
| | ConsultRm |
| DID3 | MedFollowup |
| | ConsultRm |
| DID4 | NewPatient |
| | ExamRm |
| DID5 | CholCon |
| | ConsultRm |
| | Blood |
| DID6 | DAC |
| | ConsultRm |

Whenever a digital event request 168 is made, mapper 116 correlates each digital event identifier 172 in the event request to the corresponding one or more scheduling parameters 124 that scheduler 108 needs to schedule the corresponding event 104. Mapper 116, or other component (not shown) of system 100, may then send the mapped scheduling parameters 124 to scheduler 108. Other information selected/identified by the requester, e.g., date(s), time(s), requester information, etc., that scheduler 108 needs to schedule the event(s) 104 may also be sent to the scheduler. Scheduler 108 may then use the received information to schedule the event(s) 104, which may include scheduling more than just the event itself. For example, for any one of the appointment types of Tables I-III, something other than the appointment itself must be scheduled, i.e., an exam room, a consultation room, blood test, and/or stress test equipment. The details of how the scheduler 108 performs the scheduling need not be described herein in any detail, since there are many well-known ways scheduling may be performed.

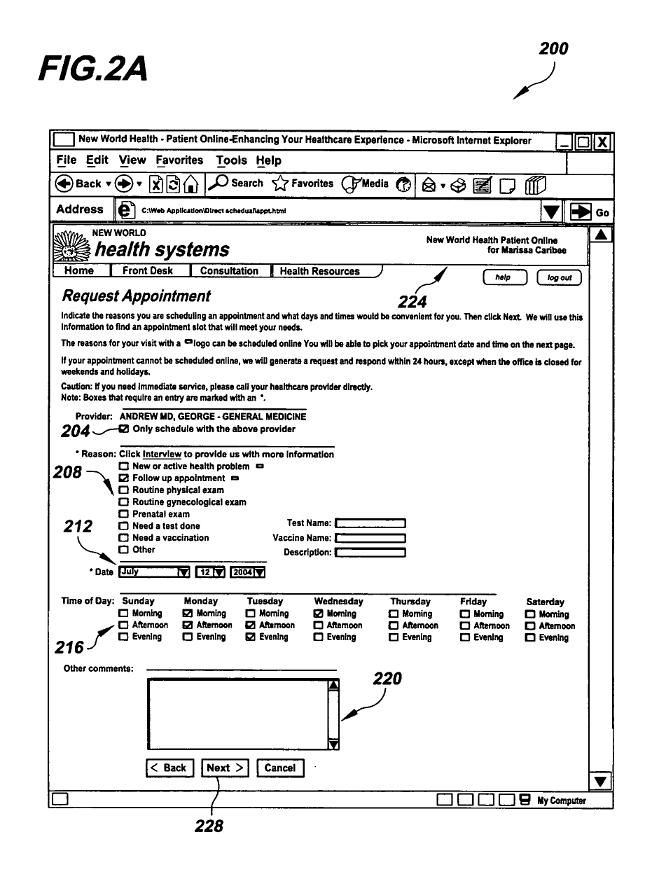

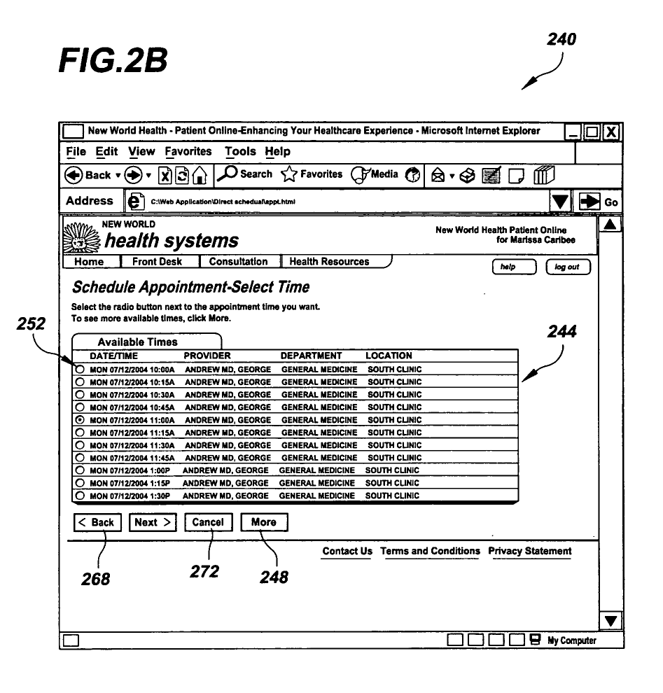

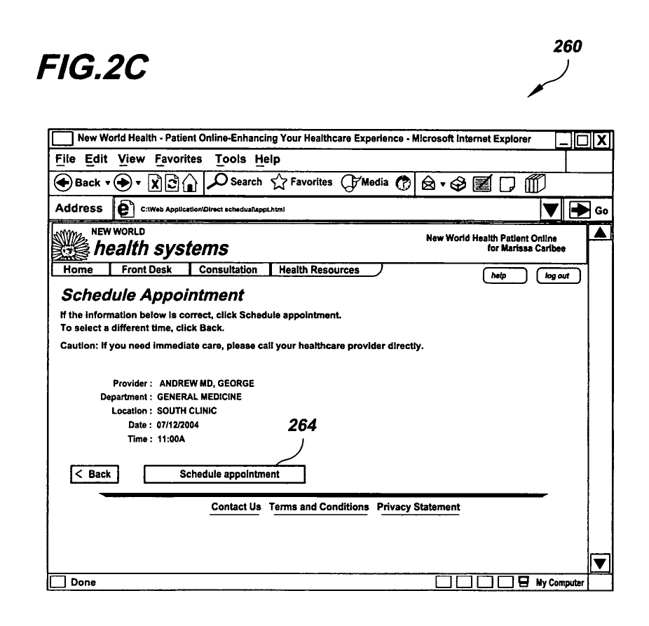

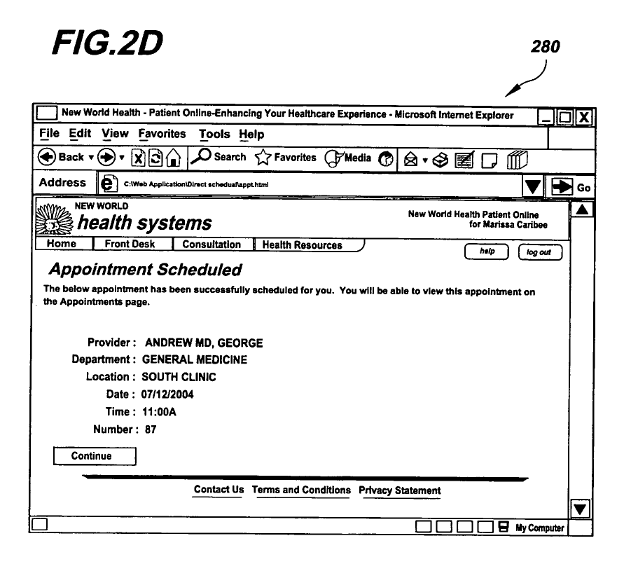

Referring to FIGS. 2A-2D, and also to FIG. 1, following is an example illustrating the scheduling of an appointment 104 with a physician using direct scheduling system 100 of FIG. 1. FIG. 2A shows a screenshot of an appointment request page 200 that user interface 112 displays (in lieu of event request page 136 of FIG. 1) to a requester via GUI 132. Appointment request page 200 is similar to event request page 136 of FIG. 1, except for some of the types of information appointment request page 200 solicits and the format of the various information selectors and input fields. In FIG. 2A, appointment request page contains, among other things: a selector 204 that allows the requester to request an appointment 104 with only a particular physician; a set of selectors 208 for designating the type of appointment the requester desires to schedule; a set of selectors 212 that allows the requester to specify a desired date for the appointment; sets of selectors 216 that allow the requester to select which one or more periods in which the requester prefers to have the appointment scheduled; and additional input fields 220 for inputting other information. It is noted that appointment request page 200 does not require the requester to input personal information, since the requester could only access this page by logging onto direct scheduling system 100, as evidenced by the custom heading 224 corresponding to the requester in this instance, “Marissa Caribee.”

In this example, direct scheduling system 100 permits the requester to directly schedule only appointments of the type a “New or active health problem” or a “Follow up appointment.” For ease of explanation, each of these appointment types has only one scheduling parameter 124 that scheduler 108 uses to schedule a corresponding appointment 104. The scheduling parameter 124 for the “New or active health problem” appointment type is “NewProb” and the scheduling parameter for the “Follow up appointment” appointment type is “FollowUp.” Correspondingly, digital appointment identifier 172 sent to mapper 116 after requester requests an appointment of the “New or active health problem” appointment type is “ApptType1,” and the digital appointment identifier 172 sent to the mapper after requester requests an appointment of the “Follow up appointment” appointment type is “ApptType2.” Consequently, mapper 116 contains correlator 176 that makes the correlation between these digital appointment identifiers 172 and scheduling parameters 124. This simple correlation is shown in Table V.

TABLE IV

| Digital Appointment Identifier | Scheduling Parameter |
|---|---|
| ApptType1 | NewProb |
| ApptType2 | FollowUp |

Consequently, when the requester makes a request to schedule an appointment 104 of either of these types, e.g., by the requester actuating a “Next>” button 228 (i.e., transmit selector 164), the corresponding digital appointment identifier 172 is sent to mapper 116, which, in turn, correlates that digital appointment identifier 172 to the corresponding respective scheduling parameter 124, which the mapper then sends to scheduler 108 for processing. It is noted that the other types of appointments that the requester cannot directly schedule, e.g., the “Need test done” and “Need a vaccination” types, may be handled in any manner known in the art. For example, digital appointment request 168 may be posted to a task list (not shown) for follow up by the physician's scheduling staff.

In this example, scheduler 108 includes a searching feature 180 that utilizes scheduling parameter(s) 127 and information provided by the requester, i.e., desired date and period of the day for scheduling appointment 104, to search for appointment times that meet the search criteria. Scheduler 108 may use each scheduling parameter 124 for, among other things, informing the searching feature of the duration of the appointment and for identifying the type of appointment to the scheduler so that when the scheduler ultimately schedules the appointment, the scheduler stores the appointment type along with the other appointment information so that the scheduler can show the type of appointment along with the time of the appointment. As shown in FIG. 2A, requester has: selected that the appointment 104 is to be scheduled only with Dr. Andrew; indicated that the appointment 104 is a follow up appointment (which has a predetermined duration of 15 minutes); indicated that Monday, Jul. 9, 2004 is the desired date for the appointment; and indicated that Monday morning and afternoon, Tuesday evening, and Wednesday morning are acceptable times for an appointment. Consequently, searching feature 180 will use these criteria for its search of available times.

Referring to FIG. 2B, after searching feature 180 has performed its search, scheduler 108 may cause user interface 112 to display an appointment selection page 240 that lists, e.g., in an available times region 244, at least a portion of the available appointment times identified by the scheduler. It is noted that in this example, all of the appointment times displayed in available times region 244 fall on the exact date that the requester requested. Of course, this need not be so. For example, if the physician's schedule 120 for Monday, Jul. 9, 2004 had been full, searching feature 180 may return the next closest times that satisfy the remainder of the requester's desires, e.g., times on the following Tuesday afternoon and/or evening and/or Wednesday morning. If there are more available times than can be displayed in available times region 244, page may include a “More” button 248 that displays additional available times in the available times region. It is noted that in this example, all of the available appointment times fall within the requested morning or afternoon periods of the requested date. Also, it is noted that no appointment times are available between 12 noon and 1:00 p.m. This is so because the physician constrained the search by blocking out this period as a lunch hour.

Appointment selection page 240 may further include one or more selectors 252, such as the radio buttons shown, that allow the requester to select one of the available appointment times. Once the requester has selected one of the available times, if the requester desires to request that time the requester would then actuate a “Next>” button 228 to transmit an interim request 184 for that time. Scheduler 108 may then receive interim request 184 and cause user interface 112 to display via GUI 132 an appointment scheduling page 260, e.g., as shown in FIG. 2C. Appointment scheduling page 260 may display the information pertinent to the appointment and request that the requester confirm the scheduling of the appointment, e.g., by the requester actuating a “Schedule appointment” button 264, or the like. Referring again to FIG. 2B, had the requester not been satisfied with any of the available times, the requester may either actuate a “<Back” button 268 to return to appointment request page 200 (FIG. 2A) so as to input new search criteria or, alternatively, actuate a “Cancel” button 272 so as to exit direct scheduling system 100.

Referring again to FIG. 2C, once the requester has confirmed the scheduling of an appointment by actuating “Schedule appointment” button 264, a final request 188 may be sent to scheduler 108 to finalize the scheduling of appointment 104. This final confirmation step may be desirable to avoid any scheduling conflicts caused by another requester or physician's staff attempting to schedule an appointment substantially contemporaneously with the request at issue. Once scheduler 108 has successfully scheduled the selected appointment 104, the scheduler may causer user interface 112 to display via GUI an appointment confirmation page 280 confirming the scheduling of the appointment 104. Had scheduler 108 scheduled another appointment 104 for the requested time between the time the scheduler received interim request 184 and the time the scheduler received final request 188, scheduler may cause user interface 112 to display via GUI 132 a scheduling conflict page (not shown) informing the requester that the desired appointment time is no longer available and/or indicating that the requester must select another time.

FIG. 3 illustrates a direct scheduling system 300 of the present invention implemented in a computer network environment 304 that includes a global computer network 308, e.g., the Internet, and a local computer network 312, such as a local area network, in communication with the global communication network, either directly, or via one or more other computer networks 316 such as a wide area network. Direct scheduling system 300 of FIG. 3 is generally similar to direct scheduling system 100 of FIG. 1 in that direct scheduling system 300 includes a scheduler 320, a user interface 324, and a mapper 328 for mapping a plurality of digital event identifiers 332 utilized by the user interface to a plurality of scheduling parameters 336 utilized by the scheduler. In this embodiment, scheduler 320 may be part of a larger application or suite of applications 340, e.g., a heath care system such as any one or more of the FLOWCAST™, CARECAST™, GROUPCAST™, and IMAGECAST™ systems mentioned above, which resides in memory 344 of an application server 348. Likewise, user interface 324 and mapper 328 may reside in memory 352 of a server, e.g., Web server 356, that communicates with application server 348 over local area network 312.

In the present embodiment, local computer network 312 is shown as being connected to global computer network 308 and other computer networks 316, if any, through Web server 356. This is to indicate that local computer network 312 is a substantially secure network relative to outside computer networks, such as global computer network 308 and other computer networks 316. In this connection, this security via a suitable firewall 358, which may be any conventional firewall. This sort of secure connectivity is desired in many, but not necessarily all, applications of direct scheduling system so as to protect information on local computer network 312 and application server 348. Of course, those skilled in the art will appreciate that local computer network may be connected to either global computer network 308 or other computer network 316 in other ways as those skilled in the art will also appreciate, in other embodiments Web server 356 and application server 348 may be one and the same, obviating the need for some of the layers of the Web server discussed below. Application/suite 340 may include one or more databases 360 containing scheduling information and any other information that the application/suite utilizes, and may further include one or more database interfaces 364 serving as one or more front ends for the database(s).

A plurality of client devices 368 may be in communication with computer networks 308, 312, and 316 so as to have access to user interface 324 of direct scheduling system 300. For example, each client device 308 may include a browser 372, e.g., a Web browser, that allows that client device 368 to connect to Web server 356 using conventional protocols. Such protocols are notorious in the art and, therefore, need not be described in any detail herein for those skilled in the art to make and use the present invention in a wired or wireless communication context. Each client device 368 may be any suitable type of device, such as a personal computer, Internet appliance, portable digital assistant, cell phone, television (via a “set top box” or the like), workstation (via a server), etc.

Web server 356 may include a data access layer 376 for communication with database interface(s) 364, e.g., using a suitable network protocol. Web server 356 may also include a business layer 380 containing mapper 328 and other features 384 necessary to provide the needed functionality, e.g., manipulating and passing information between user interface 324 and data access layer 376. Business layer 380 may further include one or more databases 388 that contains the information necessary to map digital event identifiers 332 requested via user interface 324 to scheduling parameters 336 utilized by scheduler 320. Those skilled in the art will readily be able to implement data access layer 376 and business layer 380 once the functioning of user interface 324 and scheduler 320 are known. Therefore, these layers 376, need not be described in detail herein for those skilled in the art to make and use the present invention to its fullest scope. In addition, those skilled in the are will readily appreciate that the embodiment of direct scheduling system 300 shown in FIG. 3 is merely illustrative and that many variations of the direct scheduling system may be made within the scope and spirit of the present invention.

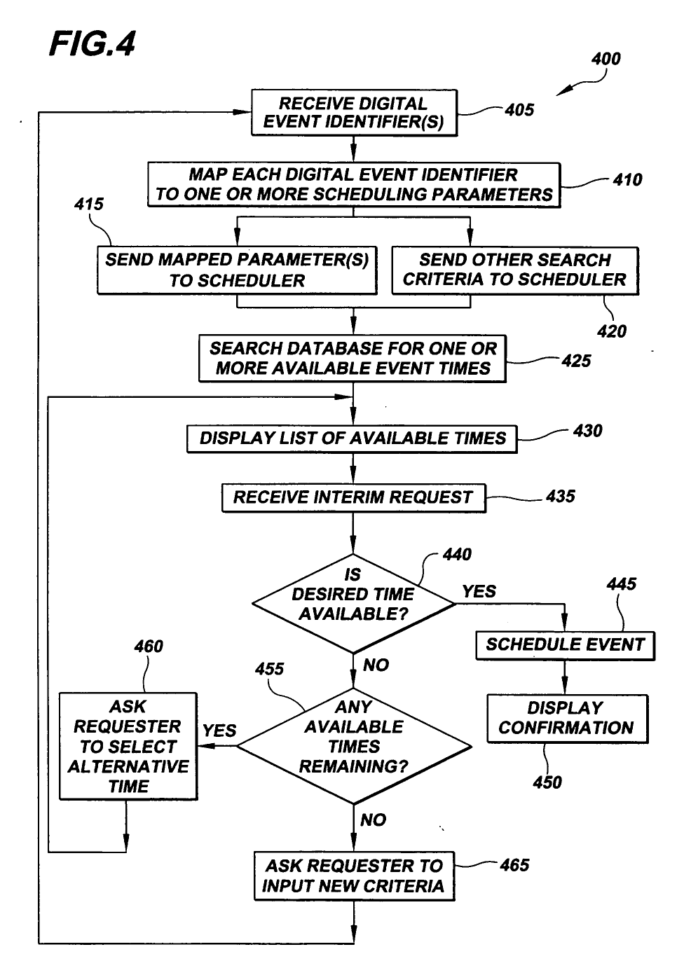

Referring to FIG. 4, and also to FIG. 3, FIG. 4 shows a flow diagram illustrating a direct scheduling method 400 that a system of the present invention, such as system 300 of FIG. 3, may perform to directly schedule an event in response to a request to schedule the event made by a requester, e.g., via a client device 368. Once the requester has made the request, at step 405 a mapper, e.g., mapper 328, receives one or more digital event identifiers, e.g., digital event identifier(s), corresponding to the request. Digital event identifier(s) 332 may be provided by browser 372 and/or user interface 324 when the requester selects one or more types of events and transmits the request as discussed above in connection with FIG. 1. At step 410, mapper 328 maps each digital event identifier 332 to one or more scheduling parameters, e.g., scheduling parameters 336, used by the scheduler at issue, e.g., scheduler 320. Once mapper 328 has determined the proper scheduling parameter(s) 336 based on digital event identifier(s) 332, at step 415 mapper 328 sends these scheduling parameter(s) to scheduler 320. At essentially the same time, at step 420 any other search criteria input by the requester and needed for scheduler 320 to perform its functions, e.g., desired date(s), time(s), etc., are sent to the scheduler, e.g., by user interface 324 and/or any or all intermediate software, e.g., business and data access layers 380, 376.

At step 425, scheduler 320 may perform a search of one or more databases, e.g., database 360, for one or more event time(s) and/or periods that satisfy and/or most closely satisfy the request. Scheduler 120 generally uses scheduling parameter(s) 336 and search criteria corresponding to the requester's request and may also utilize other built-in search constraints, such as limits on the number of “hits,” e.g., limit the search to the first ten closest available times/periods, limits on the time period searched, e.g., for a request for a particular Wednesday scheduler 320 may only search in the week containing that Wednesday, among others. Those skilled in the art will readily appreciate the variety of built-in search constraints that may be used.

At step 430, user interface 324 may display via browser 372 a list of times/periods returned by the search that are available for the event and ask the requester to select one of the available times/periods (see, e.g., appointment selection page 240 of FIG. 2B). Once the requester has identified which of the times/periods the requester desires, scheduler 320 may receive this request (see, e.g., interim request 184 of FIG. 1) at step 435 and, at step 440, determine whether or not the desired time/period is still available. As mentioned above, a competing request may have already been scheduled while system 300 is dealing with the present requester. If the desired time period is still available, at step 445 scheduler 320 may schedule the event and, at step 450, user interface 324 may display via browser 372 a scheduling confirmation (see, e.g., appointment confirmation page 280 of FIG. 2D). If, however, the desired time is no longer available, at step 455 scheduler 320 may determine if any available times/periods remain. If at least one other available time/period remains, at step 460 user interface 324 may ask the requester to select another time/period. However, if there are no more available times/periods, user interface 324 may ask the requester at step 465 to input new search criteria, e.g., a new date. Method 400 may loop back to a point between steps 425 and 430 and repeat steps 435, 440, 460 until either step 450 or 465 is reached.

Although the invention has been described and illustrated with respect to an exemplary embodiment thereof, it should be understood by those skilled in the art that the foregoing and various other changes, omissions and additions may be made therein and thereto, without parting from the spirit and scope of the present invention.

What is claimed is:

1. A method of scheduling an event, comprising the steps of:
a) receiving a digital event request from a requester via a client device;
b) executing computer instructions that map said digital event request to at least one scheduling parameter; and
c) executing computer instructions that search for one or more available event times as a function of said at least one scheduling parameter.

2. A method according to claim 1, wherein step a) comprises receiving a digital heath care appointment request.

3. A method according to claim 1, further comprising, following step c), the step of providing to said requester via said client device said one or more available event times.

4. A method according to claim 3, further comprising the step of asking said requester to select via said client device a desired one of said one or more available event times.

5. A method according to claim 4, further comprising the steps of:
a) receiving a digital interim request from said requester via said client device; and
b) executing computer instructions that schedule the event as a function of said digital interim request.

6. A method according to claim 5, further comprising the steps of:
a) receiving a digital final request from said requester via said client device; and
b) executing computer instructions that schedule the event as a function of said digital final request.

7. A method according to claim 5, further comprising the step of sending a digital event confirmation to said client computer.

8. A method according to claim 1, wherein step b) comprises executing computer instructions that map a digital event identifier to at least one scheduling parameter.

9. Computer readable media containing computer instructions for scheduling an event, the computer instructions comprising:
a) a first set of computer instructions for receiving a digital event request from a requester via a client device;
b) a second set of computer instructions that map said digital event request to scheduling parameters; and
c) a third set of computer instructions that search for one or more available event times using said scheduling parameters.

10. Computer readable media according to claim 9, wherein said first set of computer instructions comprises computer instructions for receiving a digital heath care appointment request.

11. Computer readable media according to claim 9, further comprising a fourth set of computer instructions for providing to said requester via said client device said one or more available event times.

12. Computer readable media according to claim 11, further comprising a fifth set of instructions for asking the requester to select via said client device a desired one of said one or more available event times.

13. Computer readable media according to claim 12, further comprising:
a) a sixth set of instructions for receiving a digital interim request from said requester via said client device; and
b) a seventh set of computer instructions that schedule the event as a function of said digital interim request.

14. Computer readable media according to claim 13, further comprising:
a) an eighth set of instructions for receiving a digital final request from said requester via said client device; and
b) a ninth set of computer instructions that schedule the event as a function of said digital final request.

15. A computer readable medium according to claim 13, further comprising a tenth set of instructions for sending a digital event confirmation to said client device.

16. A system for scheduling an event, comprising:
a) scheduler operatively configured to schedule a plurality of events during corresponding times using a plurality of scheduling parameters;
b) a user interface operatively configured to:
i) display a schedule request page to a requester;
ii) receive a schedule request from a requester; and
iii) permit a requester to generate a digital schedule request as a function of said schedule request; and
c) a mapper operatively configured to receive said digital schedule request and digitally map said digital schedule request to at least one of said plurality of scheduling parameters.

17. A system according to claim 16, wherein the system is for scheduling an event via a browser across at least one computer network, the system further comprising a Web server, said user interface residing on said Web server.

18. A system according to claim 17, wherein said mapper resides on said Web server.

19. A system according to claim 16, further comprising health care software comprising said scheduler.

20. A system according to claim 16, wherein said scheduler is operatively configured to schedule a health care appointment.

21. A system according to claim 16, wherein said digital schedule request contains a digital event identifier and said mapper is operatively configured to digitally map said digital event identifier to one or more of said plurality of scheduling parameters.

22. A system according to claim 16, wherein said user interface is further operatively configured to display to a requester an event selection page containing a plurality of available event times.

23. A system according to claim 22, wherein said user interface is further operatively configured to receive a digital interim request from said requester and said scheduler is further operatively configured to schedule the event as a function of said digital interim request.

24. A system according to claim 23, wherein said user interface is further operatively configured to receive a digital final request from said requester and said scheduler is further operatively configured to schedule the event as a function of said digital final request.

25. A system according to claim 23, wherein said user interface is further operatively configured to display a digital event confirmation to said requester.
